(19) United States
(12) Patent Application Publication
(10) Pub. No.: US 2005/0058761 A1
(43) Pub. Date: Mar. 17, 2005

(54) Acidified food sauces

(75) Inventors: Kenneth D. Lightfield, Appleton, WI (US); Michelle Marie Malone, Green Bay, WI (US)

Correspondence Address: BRINKS HOFER GILSON & LIONE, P.O. BOX 10395, CHICAGO, IL, 60610, US

(73) Assignee: Schreiber Foods, Inc.

(21) Appl. No.: 10/660,806

(22) Filed: Sep. 11, 2003

(51) Int. Cl. A23C 19/00

(52) U.S. Cl. 426/582

(57) ABSTRACT

A non-fermented, dairy-based food product, such as a food sauce, that is acidulated, preferably without any substantial harsh flavor or lumpy texture, and a process for making the food product. The food product may be rendered shelf stable without the necessity of exposure to high temperatures.

### BACKGROUND OF THE INVENTION

The present invention relates to high moisture, shelf-stable, dairy-based food sauces, such as cheese sauces, and a method for manufacturing them. More specifically, the invention relates to high moisture food sauces such as cheese sauces which may be prepared from traditional dairy ingredients and which are acidified for food safety in a manner that provides a superior flavor and texture, without the need for exposing the cheese sauce to refrigeration or subjecting it to aseptic processing conditions. Such cheese sauces do not have the harsh taste of acidified foods nor the grainy texture associated with dairy proteins in acidic conditions.

Process cheese sauces commercially available today are made shelf-stable either by the use of retort or “canned” aseptic processing techniques (i.e., the cheese sauce is shelf-stable until opened), or by refrigerating them to maintain food safety. “Canning” refers to a method of food preservation in which a food and its container are rendered commercially sterile or shelf-stable by the application of heat, alone or in combination with pH and/or water activity or other chemicals. As used here, “shelf-stable” refers to a food product with microbial growth controlled to a sufficient level so as to provide a safe food item to the public upon eventual consumption. Aseptic processing techniques are expensive and must conform to rigid FDA regulations; if the product is exposed to the environment, it may lose its aseptic status.

The use of a hermetically-sealed container is preferred as it maintains the sterility of the food. Commercial sterility generally means the destruction of all viable microorganisms of public health significance as well as those capable of reproducing under normal non-refrigerated conditions of storage and distribution. Commercially sterile, aseptically processed and packaged foods are considered “canned” foods even though a wide-range of packages other than metal cans may be employed, such as hermetically-sealed plastic films. The canning process depends on a series of technical operations that must be carefully and accurately performed to ensure the safety of the food.

It would be advantageous to provide a food product that is shelf stable without the necessity of conforming to closely regulated aseptic processing techniques.

Acids have long been used to limit microbial growth in foods. The addition of acids to foods is known as acidulation. Low acid foods are defined in the Code of Federal Regulations (21 CFR) as any consumable food product, other than alcoholic beverages, with a finished equilibrium pH (pHs for food sauces can drift for some time until a final, equilibrium pH is reached) of greater than 4.6 and a water activity (aw) greater than 0.85. Low acid foods also must comply with current Good Manufacturing Practices (“cGMP”) to qualify as a food or food additive.

The primary public health concern with low-acid “canned” foods is the formation of botulinal toxin. This toxin or poison is produced by a heat-resistant microorganism called Clostridium botulinum, which can cause botulism. Prevention of botulinal toxin formation is the primary reason for preserving foods by the canning process. The United States regulations surrounding the canning process are outlined in 21 CFR part 113, “Thermally Processed Low-Acid Canned Foods Packaged in Hermetically Sealed Containers.”

Acidification and/or control of water activity (aw) in conjunction with pasteurization are also procedures for maintaining commercial sterility. Acidified foods are defined as low-acid foods to which acid(s) or acid food(s) are added, and which have a water activity (aw) greater than 0.85 and a finished equilibrium pH of 4.6 or below. The United States regulations governing acidified foods are found in 21 CFR parts 108.25, 110 and 114.

In general, shelf-stable cheese sauces have been provided in the past using aseptic processing techniques. Such processes require high temperatures in excess of 200° F. to kill vegetative cells and spores. For example, U.S. Pat. No. 5,304,387 to Hine describes a method of producing a nonfat cheese sauce in which the final product is either prepared with aseptic heat treatment of 275° F. for 23 seconds and packaged while still warm (100° F.), or prepared without aseptic treatment (above about 165° F.) but stored at refrigerated temperatures of less than 45° F. to maintain a shelf life of 180 days.

Retort (high temperature/high pressure) cooking temperatures are in the 240′-300° F. range. Products that are retorted need to be formulated with ingredients that will withstand retort heat and pressures while still contributing to the overall texture of the product. For example, U.S. Pat. No. 3,628,969 to Vilim describes a method for preparing a food product containing fat, starch and milk which is subjected to retorting at temperatures greater than 212° F. and is stable against degradation at these high temperatures. As another example, U.S. Pat. No. 4,568,555 to Spanier discloses the development of a cheese sauce formulation that is made shelf-stable by the use of aseptic processing and has superior tolerance to heat. Spanier describes the use of between 5 and 15% of the weight of the cheese sauce as cheese. The product is shelf-stable until opened, after which it must be refrigerated. Starches are a key component to both of these patents. The starches used in these patents, however, may degrade under acidified conditions given the low pHs desired for use with cheese sauces of the present invention.

U.S. Pat. No. 4,689,239 to Rispoli, et al. also describes the preparation of a natural, dairy-based sauce, together with a heat treatment of 270° F.-280° F. for 30-60 seconds. Rispoli discloses pH ranges for the product of 5.1-6.6.

Aseptic processing uses very high heat and pressure to achieve sterility, resulting in moderate to extreme cooked flavors. Many of the sauces are not pleasant to taste unless they contain a substantial amount of cheese (i.e. >30% of the formulation). At these cheese levels, however, such sauces become quite expensive to produce. Further, adding vegetable particulates for flavoring (e.g., onions, peppers, celery, mushrooms or other vegetables) in aseptic processing is difficult because the vegetables do not maintain their texture and flavor integrity due to the high heat and pressure conditions.

Concentrated, lower moisture products with a water activity (aw) less than 0.85 may also be made shelf-stable, but the inconvenience of adding water back and mixing before serving may be difficult and is impractical for single-serving packages. For example, U.S. Pat. No. 6,596,336 to Gimelli et al. discloses the acidification of a concentrated sauce emulsion with high solids, low water activity (aw<0.85), high salt levels (8-12%) and preservatives each used as microbiological growth “hurdles.” The concentrated sauces are cooked/used with a dry seasoning mix, which then adjusts the final pH of the sauce for palatability.

Lower temperature processing results in a less cooked/harsh flavor but food products made by this method are not shelf-stable for food safety unless they are refrigerated.

Retort “canning” and aseptic processing also require the use of specialized, expensive equipment and licensing agreements to produce the products. In addition, once the package is opened, the product is no longer shelf-stable and it must be refrigerated in order to remain safe.

Accordingly, objects of the present invention include the provision of a low cost, shelf-stable cheese sauce having a superior flavor to aseptic/retorted products, while complying with acidified food regulations (a pH of <4.6, aw>0.85) so as not to require refrigeration or aseptic processing and equipment to maintain shelf life. Additional objects of the present invention include the ability to formulate such cheese sauces with a combination of ingredients that produce a smooth, viscous texture in which the dairy proteins are stabilized for holding up well during heating on a food-service style steam table for many hours. Although not necessarily required by the principles of the present invention, a pasteurization step is preferred as it kills the vegetative cells, while the use of acid prevents the growth of spores and spoilage organisms.

Definition of Claim Terms

The following terms are used in the claims of the patent as filed and are intended to have their broadest meaning consistent with the requirements of law.

“Acidified” as applied to a food means a low-acid food to which acid(s) or acid food(s) are added to produce a product that has a finished equilibrium pH of 4.6 or less and a water activity greater than 0.85. This term has an identical definition by the FDA.

“High heat” means temperatures at or above about 212° F.

“Ferment” means the forming of acids due to bacterial fermentation, such as the cultures used in yogurts, while “non-fermented” means the addition of acids in a manner that does not employ any substantial bacterial fermentation.

“Ready-to-eat” means a food product that is intended to be eaten as purchased without further preparation by the consumer (e.g., without mixing, re-combining, reconstituting or diluting).

“Shelf stable” means minimal microbial growth sufficient to be considered safe for human consumption and minimal flavor and texture degradation during the length of the shelf life as determined by the manufacturer, whether stored at room temperature or refrigerated. Aseptic-processed foods are considered shelf stable. Food products not falling within the FDA definition of “aseptic” may be processed using the principles of the present invention, yet may be rendered shelf stable.

“Substantially harsh flavor” means a sufficiently acidic flavor, which may or may not have a bitter component, such that those within the art at least moderately skilled in sensory work or tasting panels could demonstrate or find a perceptible flavor as such.

Where alternative meanings are possible, the broadest meaning is intended. All words used in the claims are intended to be used in the normal, customary usage of grammar and the English language.

### SUMMARY OF THE INVENTION

The objects mentioned above, as well as other objects, are solved by the present invention, which overcomes disadvantages of prior acidified food items and manufacturing methods therefore, while providing new advantages not previously obtainable.

In one embodiment of the present invention, an acidified, shelf-stable, non-fermented, dairy-based food product is provided which preferably does not possess a substantial harsh flavor. Preferably, the food product also does not possess a lumpy texture. In a preferred embodiment, the food product, which may be a food sauce such as a cheese sauce or may constitute other food products, is a ready-to-eat food product. Also preferably, the food product may be rendered shelf stable without the use of high heat.

In a preferred embodiment, the food product is formed using an acidifying agent such as acidic calcium sulfate or sodium acid sulfate, or which may consist of a combination of acids such as lactic and acetic acids. Preferred pH acidulant ranges for acidic calcium sulfate may vary between about 0.1-0.22; for sodium acid sulfate may vary between about 0.95-1.05; and for acetic/lactic acid combinations may vary between about 0.2-1.5.

One or more gums may be used to mask texture defects, such as those caused by casein precipitate. A preferred gum is a cellulose gum, or a combination of cellulose and guar.

In the case of an acidified cheese sauce, natural cheese is preferably used in the amount of about 2-6%, by weight. Preferably, the acidified food product includes about or less than about 2% salt.

In another preferred embodiment, a non-fermented, dairy-based cheese sauce is provided which is acidified without any associated substantial harsh flavor or substantial lumpy texture, and may be rendered shelf-stable without the use of high heat, high salt or low water activity (<0.85).

In yet another embodiment of the present invention, a process is provided for forming a non-fermented, shelf-stable, dairy-based, acidified food product, such as a food sauce. In this process, various ingredients may be combined, including water and natural cheese, to form a mixture. Hydrated starch, steam and an acidulant may then be introduced to the mixture to form the acidified food product. In a particularly preferred process, natural cheese in a weight range of about 2-6% is combined with water in a weight range of about 60-75%. A gum may also be added to the mixture, masking textural defects caused by casein precipitation. The acidified food product may be, but need not be, pasteurized.

### DETAILED DESCRIPTION OF THE PREFERRED EMBODIMENTS

Set forth below is a description of what is currently believed to be the preferred embodiment and/or best example of the invention claimed. Future and present alternatives and modifications to this preferred embodiment are contemplated. Any alternatives or modifications which make insubstantial changes in function, in purpose, in structure or in result are intended to be covered by the claims of this patent. All parts, percents, and ratios expressed below are provided on a weight basis.

The principles of the present invention may be applied to dairy-based food products, including but not limited to food sauces such as cheese sauces, alfredo sauces, hollandaise sauces, etc. Preferably, the ingredients making up these food sauces, for example, are mixed in a synergistic fashion to form the final food product prior to heat treatment and packaging, as will be better understood from the following disclosure.

Water is the predominant ingredient in the preferred acidified cheese sauce mixtures of the present invention. Due to their relatively high moisture contents, the fluidity of the cheese sauces according to the present invention is similar to the fluidity of heavy gravy. Thus, about 60-75%, and preferably about 65-70%, based on the total weight of the cheese sauce, is water. Those familiar with the art will understand that moisture levels this high require special handling or aseptic processing to maintain the product safe for consumption, as cheese sauces with such high moisture contents are perishable if not acidified. Typically, upon opening an aseptic cheese sauce, it either must be brought above and held at 145° F. or kept refrigerated to prevent bacterial degradation. Such measures are not necessary with the acidified cheese sauces made according to the present invention, however, which are truly shelf stable, for the reasons described below.

Acidulant usage rates depend upon the pH of the other raw materials making up the blend. Samples are taken once all ingredients are added and blended, and then a pH reading is taken. Acidulant usage rates are dependent upon these readings but generally run between about 0.5%-2.5%.

Lactic acid is commonly used in dairy products as an acidifying agent, and provides some flavor components along with its pH-lowering ability. It was found that the level of lactic acid needed to drop the pH below 4.5 was quite large, however, and resulted in a harsh flavor. A combination of lactic and acetic acids, similar to what is found in yogurts, was found to be a substantial improvement. Preferred pH ranges for acidulants made of lactic/acetic acid combinations are between about 0.2-1.5. Different ratios of lactic to acetic acid were tried, including 75/25, 50/50, 25/75, with an about 50/50 blend being preferred.

Flavor improvements were still desired. Acidic calcium sulfate having a pH substantially less than 2.0, available from Mionix Corporation of Rockland, Calif., was tried as an acidulant and was found to have a low usage rate as compared to other acidifying agents. While this significantly reduced overall acid bite, a substantially harsh flavor still existed. (It is also believed that sodium acid sulfate may be useable as an acidulant in this regard.) Accordingly, dairy flavors were then added to increase the overall dairy flavor and reduce the harsh flavor.

Unacceptable texture or body issues were also encountered during the development of acidified cheese sauces according to the present invention. The problem is caused by casein, the major dairy protein which has an isoelectric point at a pH of 4.6. The protein precipitates when this pH is reached, causing undesirable defects in cheese sauce. With cheese sauces having a pH of less than 4.6 as mentioned above, the resulting texture is similar to that of oatmeal. To address this problem, it was discovered that a cellulose gum alone, or a cellulose gum in combination with another gum, may be used. The current, particularly preferred gum system is a combination of cellulose and guar gum called Bekaplus Q3B, with a usage rate of about 0.1-0.6%, and a particularly preferred usage rate of about 0.3-0.5%.

Phosphates may also be used in the preparation of the cheese sauce to aid in emulsification. The phosphates used may be of ortho, tetra, poly, tri-poly or any combination thereof. A preferred phosphate complexing salt that may be used is a sodium polyphosphate. The commercial name of one preferred product is JOHA C new, manufactured by BK Giulini, of Chemie, Germany, which may be added to the cheese sauce at 0.1-0.5%. This phosphate was found to work well at low pHs and to actually have a pH-lowering effect of its own. This product is commonly used in sour creams and cream cheese products which have a lower pH value as compared to other dairy products.

About 2%-6% natural cheese may be used in making cheese sauces according to the present invention. Preferably, Cheddar cheese is used; however, Mozzarella, Monterey Jack, Provolone or any other varieties or mixtures of natural cheeses may be used depending upon the type or variety of cheese sauce that is desired. Usage levels may be adjusted to meet the desired flavor and/or viscosity targets. The usage level of natural cheese is considerably lower when compared to prior sauces. For example, U.S. Pat. No. 4,568,555 discloses a usage level of 6%-11% of natural cheese. The lower cheese percentage which may be utilized by the present invention represents a cost savings and allows the cheese sauce to be more robust when used in its final application. Natural cheese serves several functions in this invention. Natural cheese provides a source of protein, fat and flavor. The protein portion provides a backbone or matrix that helps binds the fat and other oils into an emulsion. In addition to the protein from the cheese, other dairy proteins may also serve this function. Milk protein concentrate, rennet casein, caseinates, nonfat dry milk, whey protein concentrate, whey powder and skim cheese powder are each possible sources for this purpose. Two preferred sources are whey powder and skim cheese powder. Whey powder may be used for several reasons: low cost; the water binding capacity of the whey proteins; and its bulking capability relative to price. Skim powder has a low relative usage level but consists mostly of protein and it adds a flavor to the sauce. Together, these powders may be used in a range of about 4-10% with the preferred range being about 5-9%.

Soybean oil may be used as the primary source of fat, although butterfat and other vegetable fats may also be used. Soybean oil has traditionally been used in cheese sauces, as it delivers a relatively clean flavor without many off-flavors compared to other fat sources in the same price range. It provides a smooth mouth feel in the finished product and provides the lipid flavor profile. Butterfat may be used to produce a sauce with a premium flavor profile; however, it is more costly. The fat sources may be used in the range of about 2-10%, with a preferred range of about 5-9%.

Corn syrup solids are another bulk constituent that may provide both a source of low cost solids and a very positive flavor impact. Corn syrup solids provide a sweet note and take some of the acid bite away from the overall flavor profile. Corn syrup solids may be used in the range of about 1-5%, with preferred range of about 2-3%.

Different items whose primary function is to positively impact flavor may be added in relatively small percentages, depending upon the desired taste, as now described. Salt may be added at, e.g., levels of about 1-2%. These levels are somewhat adjustable as they are dependent upon the salt level in the other ingredients. The amount of salt is adjusted so that the finished product has a salt content which is preferably between about 1.5-2.1%. Salt levels for sauces according to the present invention are typically not high enough for food safety. The salt amount is adjusted based on what is acceptable to the end user from a flavor standpoint. Various dairy flavoring ingredients such as enzyme-modified cheeses and dairy flavors, masking agents and the like may also be added to further modify the flavor based on preferences.

It is believed that the defects referenced above that are commonly associated with acidified dairy products have more than likely prevented the commercial production and sale of acidified cheese sauces. The low pH of cheese sauces made according to the principles of the present invention provides many benefits for such cheese sauces as mentioned above, including but not limited to shelf stability, increased keeping quality, and lower cook temperatures required during manufacturing. As mentioned, the low pH conditions of these cheese sauces also create major defects which must be nullified if a commercially viable acidified cheese sauce is to be provided. These defects present in conventional acidified cheese sauces include: unpalatable flavor (extreme acid and/or bitter taste); and unacceptable body (oatmeal-like texture) due to casein's natural tendency to precipitate out at its isoelectric point at a pH of 4.6. The present invention overcomes these defects using the principles described above.

In the preferred embodiment of acidified cheese sauces, such sauces made according to the principles of the present invention may be prepared according to the following formula ranges:

| | | Particularly |
|---|---|---|
| Ingredient | Range % By Weight | Preferred Range |
| Natural Cheese | 2-6 | 3.5-4.5 |
| Artificial Color | 0.1-0.2 | .125-.175 |
| Corn Syrup Solids | 1-5 | 2-3 |
| Soybean Oil | 2-10 | 5-9 |
| Salt | 1-2 | 1.5-2 |
| Gums | 0.1-0.6 | .3-.5 |
| Mono & diglycerides | 0.05-0.25 | .10-.15 |
| Phosphates | 0.1-0.5 | .2-.4 |
| Modified Corn Starch | 1-7 | 3-5 |
| Maltodextrin | 0.5-3.0 | 1-2 |
| Acidulant | 0.1-6 | 0.5-1.0 |
| Natural Dairy Flavors | 1-4 | 1-2 |
| (Dairy Proteins) | 4-10 | 5-9 |
| Vegetables/ | 0.75-3.5 | 1-2 |
| Condiments | | |
| (Optional) | | |
| Water | 59-75 | 65-70 |

Appropriate processing ranges for preferred acidified cheese sauces prepared according to the principles of the present invention will now be described. Cook temperatures of 170-210° F. may be used; however, about 185° F. is preferred. pH values of 3.0-4.6 may be used, with about 4.4 being preferred. Preferred acidulants include lactic, acetic, citric, glucono delta lactone, butyric, acidic calcium sulfate, sodium acid sulfate or combinations of these acidulants. Sodium acid sulfate is available from Jones-Hamilton Company of Walbridge, Ohio. Currently, a particularly preferred acidulant is acidic calcium sulfate available from Mionix. Preferred pH ranges for the preferred acidic calcium sulfate acidulants are between about 0.1-0.22, and for sodium acid sulfate acidulants are between about 0.95-1.05.

Preferred gums include guar, xanthan, CMC (carboxylmethyl cellulose), locust bean, carrageenan, cellulose or combinations thereof.

Preferred emulsifying agents include monosodium phosphate, disodium phosphate, sodium hexametaphosphate, sodium aluminum phosphate and sodium polyphosphate, sodium citrate, and mono and diglycerides. A particularly preferred emulsifying combination is sodium polyphosphate with Panodan 150 K. Panodan 150 K, manufactured by Danisco, is a blend of diacetyl tartaric acid ester of mono and diglycerides (DATEM), and mono and diglycerides made from edible, refined vegetable fats.

One preferred cheese sauce according to the present invention may be provided using the following blending and cook procedure. The following items are placed into a clean tub at this given percent in this order: aged cheddar cheese, 3.9% of total cook; whey powder, 6.8%; dried skim cheese, 1.0%; solid soybean oil, 7.7%. These items are then dumped into a grinder and the ground items are transferred into a Reitz cooker. It will be understood that any of a variety of cookers may be used that accomplish the requisite functions described here. As the ground items are being fed into the cooker, water may be added at this time (approximately 40-50% of the blend). Next, the items in the cooker are continuously agitated on high speed while the following items are added: corn syrup solids, 2.3%; salt, 1.7%; Bekaplus Q3B, 0.34%; DATEM (diacetyl tartaric acid ester of mono-diglycerides), 0.13%; JOHA C, 0.34%; sorbic, 0.2%; sunflower yellow color, 0.14%; carotenal #73, 0.001%; butter cream 100, 0.2%; autolysed yeast extract, 0.1%; and dairy flavors, 1.6%.

Once all items have been added to the agitating cooker, mixing continues on high speed. Steam is then introduced to bring the temperature of the mixture to between about 145-150° F. During this time, a starch mixture is weighed and hydrated with water in a separate tank. The hydrated starch mixture, once blended with the mixture in the cooker, represents about 24.5% of the total mixture. A breakdown of the components for the starch mixture is as follows. The first percentage listed represents the weight percent with relation to the hydrated starch mixture, while the second percentage represents the weight percent with relation to the total mixture: water, 79.6%, 19.5%; maltrin, 4.1%, 1.0%; Pure-Gel-B994, 16.31%, 4.0%.

Once the ingredients in the cooker have been brought to between about 145-150° F., the hydrated starch solution is then transferred to the cooker along with any other condiments or vegetables if a sauce other than plain cheese sauce is being made. An acidulant, e.g., Mionix 560, may now be added, at about 0.5-0.7%, with usage levels being dependent upon the desired pH of the sauce. Acidulant usage levels should be adjusted so that the pH is less than about 4.4.

The total mixture with the hydrated starch solution may now be cooked to about 185° F. using high steam and high speed mixing. This is the pasteurization step. The moisture and pH levels of the mixture should be checked, with adjustments made if necessary based on the desired levels. Moisture levels may be checked using a CEM oven, for example. Upon reaching targeted pH and moisture levels, the mixture may then be discharged into a balance tank and pumped through either a high shear pump or a homogenizer for transfer into a packaging machine.

In an alternative embodiment according to another aspect of the present invention, the same process as set out above may be followed, except that the starch and Maltrin may be hydrated in the same cooking vessel in which the sauce is blended and then cooked using the above-mentioned blending and cooking steps. The process referenced above is then followed with the exception that the starch materials are first hydrated in the same cooking and blending vessel, as follows. The bottom of the cooker is filled with water in the amount of 19.5% of the total mixture. The cooker's agitators are turned on at high speed, and the following is added to the water: Maltrin, 1.0%; Pure Gel B994, 4.0%. Once the starch has been adequately hydrated, the remaining ingredients may be added.

Those of ordinary skill in the art will appreciate that appropriate industry approval is necessary before cheese sauces made according to the principles of the present invention may be used in the marketplace.

Suitable packaging machines may take a variety of forms, including vertical form fill and sealing machines such as those disclosed in U.S. Pat. Nos. 5,112,632, 5,440,860, 5,701,724 and 6,058,680, the disclosures of which concerning such packaging machinery and processes are each hereby incorporated by reference herein. Other packaging which may be used in connection with storing and/or packaging sauces according to the present invention include, but is not necessarily limited to, flexible pouches, bags, bag-in-box, bags with hose fittings, glass jars and bottles, injection-molded plastic bottles, cups, tubs and pails, metal cans, thermoformed cups and tubs, large bulk bags in corrugated totes, and plastic or metal barrels.

It will be understood by those of ordinary skill in the art reading the above disclosure that food products made according to the principles of the present invention need not be made shelf stable, and may be refrigerated for quality concerns.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims.

1. An acidified, shelf stable, non-fermented, dairy-based food product comprising an acidifying agent, wherein the food product does not possess a substantially harsh flavor.

2. The food product of claim 1, wherein the food product does not possess a lumpy texture.

3. The food product of claim 1, comprising a ready-to-eat food product.

4. The food product of claim 1, wherein the food product is rendered shelf stable without the use of high heat.

5. The food product of claim 1, wherein the food product contains an acidulant with a pH of less than about 4.

6. The food product of claim 5, wherein the food product contains an acidulant with a pH of between about 0.1 to 1.5.

7. The food product of claim 6, wherein the food product contains an acidulant with a pH of between about 0.1-0.22.

8. The food product of claim 1, wherein the food product comprises a cheese sauce.

9. The food product of claim 1, wherein the food product is formed using an acidifying agent comprising a combination of acids.

10. The food product of claim 1, wherein the acidifying agent comprises acidic calcium sulfate.

11. The food product of claim 1, wherein the acidifying agent comprises sodium acid sulfate.

12. The food product of claim 1, wherein the acidifying agent comprises a combination of acetic and lactic acids.

13. The food product of claim 1, wherein the food product utilizes a gum masking textural defects in the food product.

14. The food product of claim 13, wherein the gum comprises a cellulose gum.

15. The food product of claim 13, wherein the gum comprises a combination of cellulose and guar.

16. The food product of claim 1, wherein the food product utilizes a gum to mask texture defects caused by casein precipitation.

17. The cheese sauce of claim 8, comprising between about 2-6% natural cheese.

18. The food product of claim 1, wherein the food product comprises about or less than about 2% salt.

19. A non-fermented, dairy-based cheese sauce acidified not having an associated substantially harsh flavor or substantially lumpy texture, and rendered shelf stable without the use of high heat.

20. A process for forming a non-fermented, shelf-stable, dairy-based, acidified food product, comprising the steps of:
combining various ingredients including water and natural cheese to form a mixture; and
introducing hydrated starch, steam and an acidulant to the mixture to form the acidified food product.

21. The process of claim 20, wherein the food product is derived by mixing natural cheese in a weight range of about 2-6% and water in a weight range of about 60-75%.

22. The process of claim 20, further comprising the step of adding a gum to the mixture, the gum masking textural defects caused by casein precipitation.

23. The process of claim 20, wherein the food product comprises a food sauce.

24. The process of claim 20, further comprising the step of pasteurizing the acidified food product.
